(19) United States
(12) Patent Application Publication
(10) Pub. No.: US 2008/0055431 A1
(43) Pub. Date: Mar. 6, 2008

(54) Dark frame subtraction using multiple dark frames

(75) Inventors: Juha Alakarhu, Tampere (FI); Harri Ojanen, Helsinki (FI)

Correspondence Address: WARE FRESSOLA VAN DER SLUYS & ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/514,684

(22) Filed: Aug. 31, 2006

(51) Int. Cl. H04N 5/217

(52) U.S. Cl. 348/241

(57) ABSTRACT

The specification and drawings present a new method, apparatus and software product for a dark frame subtraction using multiple dark frames by storing only one frame at a time, i.e., using only one frame storage so that the amount of memory can be minimized. Divisional and multiplication algorithms can be used for the dark frame subtraction.

### TECHNICAL FIELD

The present invention relates generally to electronic devices comprising cameras and, more specifically, to a dark frame subtraction using multiple dark frames.

### BACKGROUND ART

An image sensor is the component of a digital camera, which converts a visible light to an electronic signal. Several noise components appear in this light sensing process, which degrade the image quality.

The image sensor comprises an array of pixels. Typically one digital value is generated for each pixel. The digital value comprises of: a) an actual signal caused by light, b) a dark signal and c) a signal with various noise components. To improve the image quality, several methods can be used to extract the actual signal from the dark signal and the noise components.

One of the methods is called a dark frame subtraction. Here, two images are captured: A) the scene to be captured (primary frame), and B) a dark frame in which the sensor is not illuminated. When these two frames are captured, the dark signal can be compensated (e.g., subtracted) pixel by pixel.

The dark signal is a linear function of the exposure time and an exponential function of the temperature. In addition, the dark signal varies from pixel to pixel (even though their temperature and exposure times can be the same). The variation of the dark signal from pixel to pixel is called a dark signal non-uniformity (DSNU). To compensate the DSNU, the dark frame subtraction method can be used.

In simple dark frame subtraction, only one dark frame is captured in addition to the primary frame. However, this simple method has a problem: whenever image sensor is read, there are always uncorrelated noise components. Subtracting the dark frame increases the amount of the noise related to the uncorrelated noise components (they cannot be subtracted because they are uncorrelated, i.e., different in the primary and dark frames). If the magnitude of the uncorrelated noise components is larger than the dark signal non-uniformity, subtracting the dark frame can increase the total noise and can degrade the image quality, as shown in the following simplified equations:

Primary frame(single pixel): s(signal)+d(dark signal)+n1(noise);

Dark frame (single pixel): d (dark signal)+n2 (noise, which is different than in the primary frame); subtracting the dark frame from the primary frame gives: s+d+n1−d−n2=s+(n1−n2), thus potentially increasing the system noise because of uncorrelated noise components n1 and n2.

To solve this problem, several dark frames can be used and averaged in order to average the temporal uncorrelated noise components out. In a simple implementation of this method, the primary frame is captured and stored to a frame storage (memory) and dark frames are stored to another frame storage area and averaged. This approach, however, requires at least two frame storages (or two memory areas for frame storage), which can increase the cost and size of the system.

### DISCLOSURE OF THE INVENTION

According to a first aspect of the invention, a method comprises: capturing a primary frame and a plurality of dark frames by an electronic device; performing a dark frame subtraction using the primary frame and the dark frames according to a predetermined algorithm by the electronic device by storing only one frame at any time during the capturing and the performing.

According further to the first aspect of the invention, the performing dark frame subtraction may comprise: storing pixel values of the primary frame in a memory of the electronic device; and dividing pixel values of each of the plurality of the dark frames by a predetermined number equal to the plurality to generate divided pixel values and subtracting the divided pixel values of the each of the plurality of the dark frames from corresponding pixel values of the primary frames stored in the memory. Further, the dividing and subtracting may be performed for each of the plurality of the dark frames right after capturing the each dark frame such that none of the pixel values of the dark frames are stored in the memory, and the only one frame is stored in the memory at any time during the dividing and subtracting.

According further to the first aspect of the invention, the performing dark frame subtraction may comprise: multiplying each pixel value of the primary frame by a predetermined number equal to the plurality to generate multiplied pixel values and storing the multiplied pixel values in a memory of the electronic device; and subtracting pixel values of each of the plurality of the dark frames from corresponding pixel values of the multiplied pixel values to generate subtracted pixel values and dividing the subtracted pixel values by the predetermined number. Further, the subtracting may be performed for each of the plurality of the dark frames right after capturing the each dark frame such that none of the pixel values of the dark frames are stored in the memory, and the only one frame is stored in the memory at any time during the multiplying and subtracting.

Still further according to the first aspect of the invention, the performing dark frame subtraction may comprise: dividing each pixel value of each of the plurality of the dark frames by a predetermined number equal to the plurality to generate divided pixel values and adding the divided pixel values of the each of the plurality of the dark frames one at a time to generate added pixel values and storing the added pixel values in a memory of the electronic device; and subtracting the added pixel values of the plurality of the dark frames from corresponding pixel values of the primary frame. Further, the dividing and adding may be performed for each of the plurality of the dark frames right after capturing the each dark frame such that only one frame is stored in the memory at any time during the dividing, adding and subtracting.

According further to the first aspect of the invention, the performing dark frame subtraction may comprise: adding pixel values of each of the plurality of the dark frames one at a time to generate added pixel values and storing the added pixel values in a memory of the electronic device; and multiplying each pixel value of the primary frame by a predetermined number equal to the plurality to generate multiplied pixel values and subtracting the added pixel values of the plurality of the dark frames from corresponding the multiplied pixel values of the primary frame to generate subtracted pixel values and dividing the subtracted pixel values by the predetermined number. Further, the adding may be performed for each of the plurality of the dark frames right after capturing the each dark frame such that the only one frame is stored in the memory at any time during the adding, multiplying, subtracting and dividing.

According still further to the first aspect of the invention, the plurality may have a value between two and sixteen.

According further still to the first aspect of the invention, the electronic device may comprises a camera performing the capturing of the primary frame and the plurality of the dark frames, and performing the dark frame subtraction.

According to a second aspect of the invention, a computer program product comprises: a computer readable storage structure embodying computer program code thereon for execution by a computer processor with the computer program code, wherein the computer program code comprises instructions for performing the first aspect of the invention, indicated as being performed by any component or a combination of components of the electronic device.

According to a third aspect of the invention, an electronic device, comprises: a sensor, for capturing a primary frame and a plurality of dark frames; processing/control module, for performing a dark frame subtraction using the primary frame and the dark frames according to a predetermined algorithm by storing only one frame at any time during the capturing and the performing; and a memory, for storing the only one frame during the capturing and the performing.

Further according to the third aspect of the invention, the electronic device may further comprise: a mechanical shutter, for providing the capturing of the plurality of the dark frames. Further, the mechanical shutter responsive to a control signal from the processing/control module to close for the capturing of the plurality of the dark frames or to open to capture the primary frame. Further still, the sensor, the mechanical shutter and the processing/control module may be parts of a camera.

Still further according to the third aspect of the invention, the performing dark frame subtraction may comprise: storing pixel values of the primary frame in a memory of the electronic device; and dividing each pixel value of each of the plurality of the dark frames by a predetermined number equal to the plurality to generate divided pixel values and subtracting the divided pixel values of the each of the plurality of the dark frames from corresponding pixel values of the primary frames stored in the memory.

According further to the third aspect of the invention, the performing dark frame subtraction may comprise: multiplying each pixel value of the primary frame by a predetermined number equal to the plurality to generate multiplied pixel values and storing the multiplied pixel values in a memory of the electronic device; and subtracting pixel values of each of the plurality of the dark frames from corresponding pixel values of the multiplied pixel values to generate subtracted pixel values and dividing the subtracted pixel values by the predetermined number.

According still further to the third aspect of the invention, the performing dark frame subtraction may comprise: dividing each pixel value of each of the plurality of the dark frames by a predetermined number equal to the plurality to generate divided pixel values and adding the divided pixel values of the each of the plurality of the dark frames one at a time to generate added pixel values and storing the added pixel values in a memory of the electronic device; and subtracting the added pixel values of the plurality of the dark frames from corresponding pixel values of the primary frame.

According yet further still to the third aspect of the invention, the performing dark frame subtraction may comprise: adding pixel values of each of the plurality of the dark frames one at a time to generate added pixel values and storing the added pixel values in a memory of the electronic device; and multiplying each pixel value of the primary frame by a predetermined number equal to the plurality to generate multiplied pixel values and subtracting the added pixel values of the plurality of the dark frames from corresponding the multiplied pixel values of the primary frame to generate subtracted pixel values and dividing the subtracted pixel values by the predetermined number.

According further still to the third aspect of the invention, the plurality may have a value between two and sixteen.

According to a fourth aspect of the invention, an electronic device, may comprise: means for capturing a primary frame and a plurality of dark frames by an electronic device; means for performing a dark frame subtraction using the primary frame and the dark frames according to a predetermined algorithm by the electronic device by storing only one frame at any time during the capturing and the performing; and means for storing the only one frame during the capturing and the performing.

According further to the fourth aspect of the invention, the means for capturing may be an image sensor.

### BRIEF DESCRIPTION OF THE DRAWINGS

For a better understanding of the nature and objects of the present invention, reference is made to the following detailed description taken in conjunction with the following drawings, in which:

FIG. 1 is a block diagram of an electronic device comprising a camera for a dark frame subtraction using multiple dark frames by storing only one frame at a time, according to an embodiment of the present invention.

FIGS. 2a and 2b are flow charts of alternative divisional methods for a dark frame subtraction using multiple dark frames by storing only one frame at a time, according to an embodiment of the present invention; and

FIGS. 3a and 3b are flow charts of alternative multiplication methods for a dark frame subtraction using multiple dark frames by storing only one frame at a time, according to an embodiment of the present invention.

### MODES FOR CARRYING OUT THE INVENTION

A new method, apparatus and software product for a dark frame subtraction using multiple dark frames by storing only one frame at a time, i.e., using only one frame storage so that the amount of memory can be minimized. The electronic device can be, but is not limited to, a camera, a digital camera, a wireless communication device, a mobile phone, a camera-phone mobile device, a portable electronic device, non-portable electronic device, etc.

According to embodiments of the present invention, a primary frame and a plurality of dark frames can be captured by an electronic device, which can perform a dark frame subtraction using the primary frame and the dark frames according to a predetermined algorithm by storing only one frame at any time during said capturing the frames and performing the dark frame subtraction.

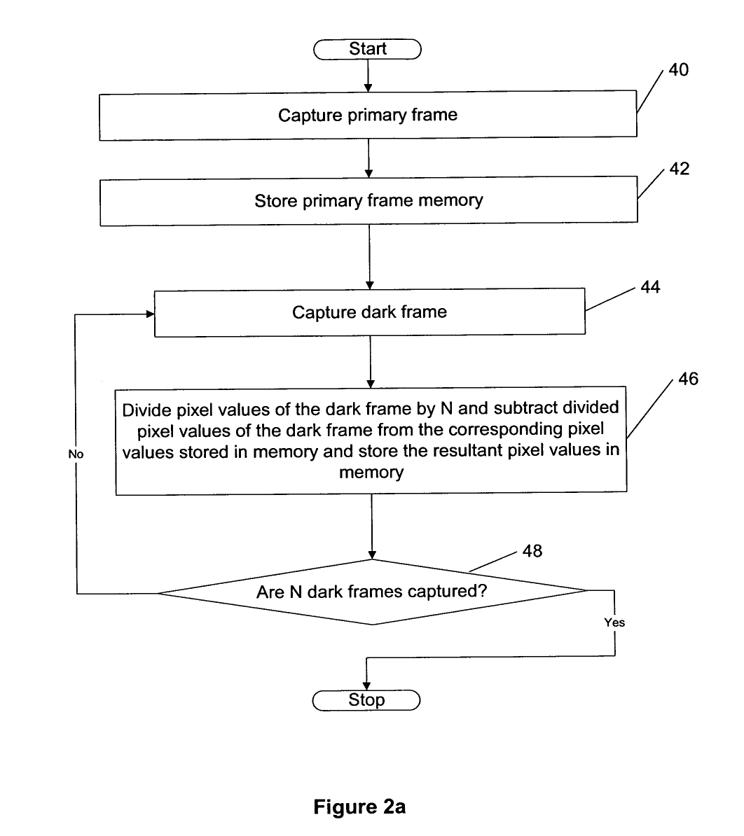

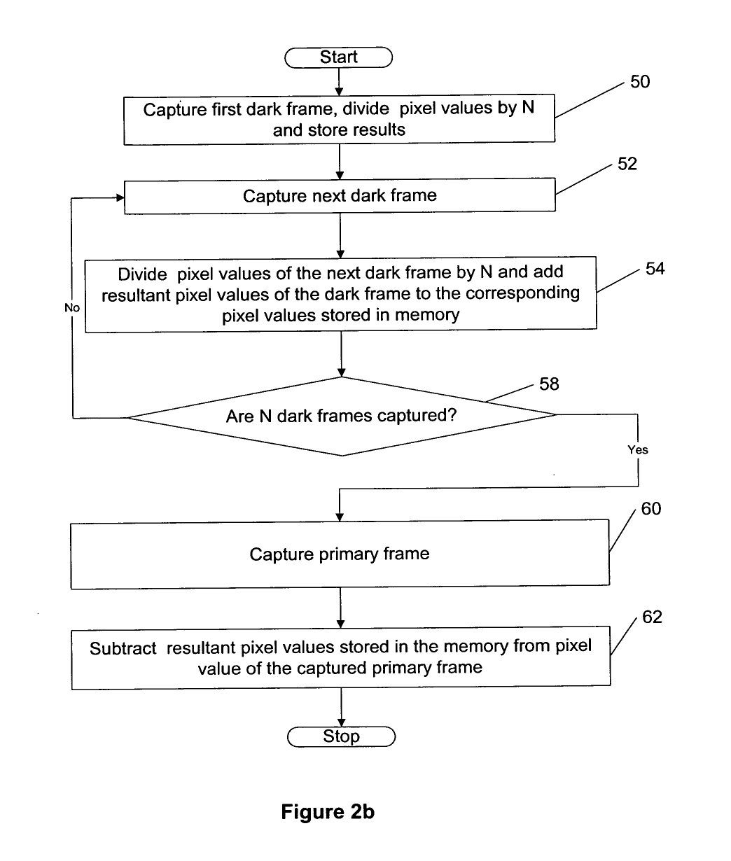

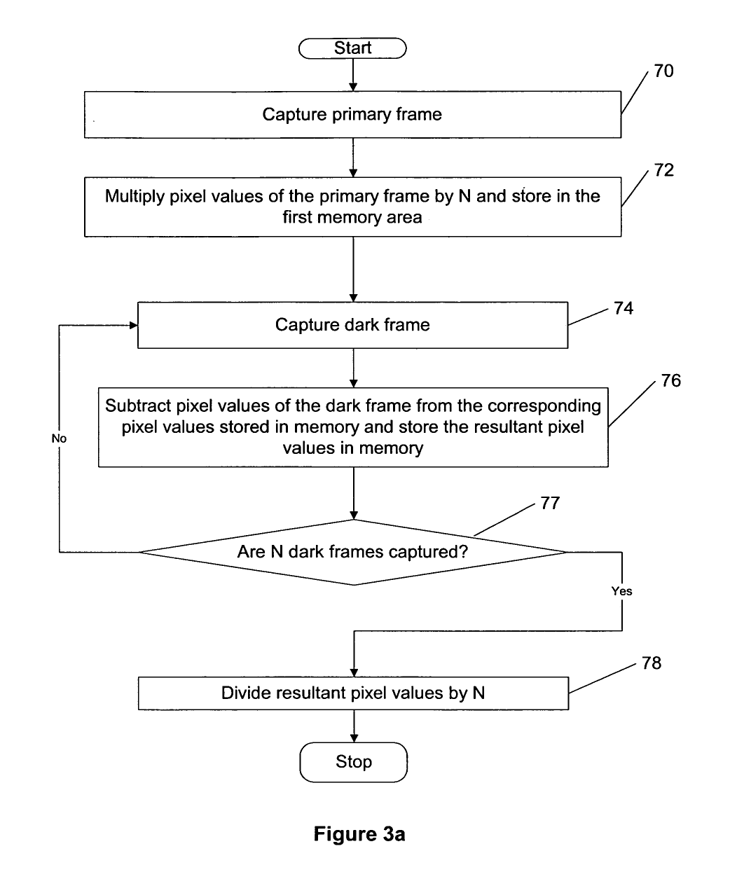

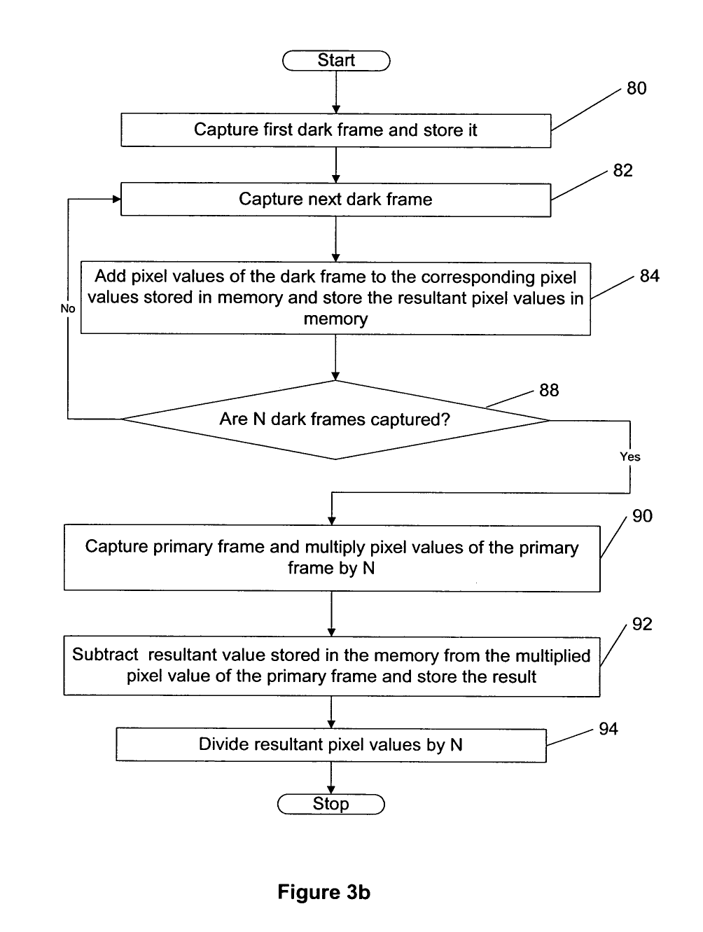

For example, according to one embodiment, the primary frame can be stored to the memory area A. The same memory area A can be used for the dark frames. The subtraction from the primary frame can be done on the fly while the dark frames are being read. To be able to capture multiple dark frames, either of the following methods can be used: a dark frame signal is divided by a total number of the dark frames before subtracting it from a content of the memory, or the primary frame is multiplied by the number of the dark frames before the subtraction. Detailed examples of these implementations are presented in regard to FIGS. 2a and 3a.

According to another embodiment, the dark frames can be captured and stored first and primary frame is captured afterwards. In this case, the dark frames, e.g., can first add to the memory negative values divided by the total number of dark frames, which is afterwards compensated by a dark frame signal of the primary frame. In an alternative scenario, the dark frames can first add negative values directly to the memory, which is afterwards compensated by the dark signal of the primary frame multiplied by the total number of the dark frames. Detailed examples of these implementations are presented in FIGS. 2b and 3b.

It is noted that various embodiments of the present invention recited herein can be used separately, combined or selectively combined for specific applications.

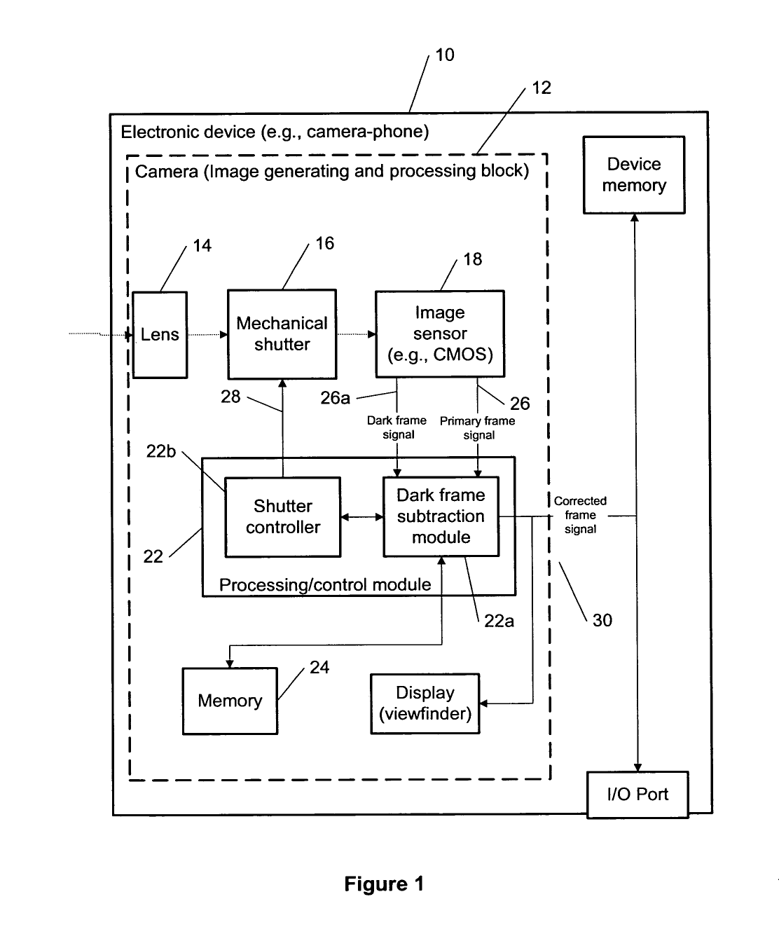

FIG. 1 shows an example among others of a block diagram of an electronic device 10 comprising a camera 12 for a dark frame subtraction using multiple dark frames by storing only one frame at a time, according to an embodiment of the present invention. The electronic device 10 can be, but is not limited to, a camera, a digital camera, a wireless communication device, a mobile phone, a camera-phone mobile device, a portable electronic device, non-portable electronic device, etc.

The camera 12 can comprise a lens 14 and an image sensor 18 (e.g., the CMOS sensor) for capturing the image of the object or the primary frame shown as a primary frame signal 26, when a mechanical shutter 16 is in an open position. The dark frames can be captured (shown as a dark frame signal 26a) using the mechanical shutter 16 in a closed position (i.e., the image collected by the lens 14 is excluded). A processing/control module 22 can comprise a dark frame subtraction module 22a which can be used for performing the dark frame subtraction using the primary frame and the dark frames according to a predetermined algorithm by storing in a memory 24 only one frame at any time during said capturing the frames and during the performing the dark frame subtraction, thus generating a corrected frame signal 30, according to various embodiments of the present invention discussed herein (also see detailed implementations presented in FIGS. 2a, 2b, 3a and 3b). The module 22 can be configured to control operation of the mechanical shutter 16, e.g., using a shutter controller 22b, by sending a corresponding open/closed command signal 28. The corrected frame signal 30 can be provided (optionally) to different modules of the electronic device 10, e.g., to a display (viewfinder) for viewing, to a device memory for storing, or to an input/output (I/O) port for forwarding to a desired destination.

The block 24 can be a dedicated block in the camera module 12 or it can be incorporated within the module 22 or other modules of the electronic device 10.

According to an embodiment of the present invention, the module 22, 22a, or 22b can be implemented as a software or a hardware block or a combination thereof. Furthermore, the block 22, 22a, or 22b can be implemented as a separate block or can be combined with any other block of the electronic device 10 or it can be split into several blocks according to their functionality.

FIGS. 2a, 2b, 3a and 3b demonstrate flow charts of various implementation scenarios for implementing the dark frame subtraction “on the fly” using only one frame storage, according to embodiments of the present invention. It is noted that the order of steps shown in each of FIGS. 2a, 2b, 3a or 3b is not absolutely required, so in principle, the various steps can be performed out of order.

FIG. 2a shows a flow chart of a divisional method for a dark frame subtraction using multiple dark frames by storing only one frame at a time, according to an embodiment of the present invention; and

The flow chart of FIG. 2a only represents one possible scenario among others. In a method according to the first embodiment of the present invention, in a first step 40, the primary frame is captured (e.g., see the primary frame signal 26 in FIG. 1) by the camera 12 when the mechanical shutter 16 is in an open position. In a next step 42, the primary frame is stored, e.g., in the memory 24 (frame storage area).

In a next step 44, the dark frame is captured (e.g., see the dark frame signal 26a) by the camera 12 when the mechanical shutter 16 is in a closed position.

In a next step 46, the pixel values of the captured dark frame are divided by N (e.g., using the module 22a) and the divided pixel values of the dark frame are subtracted from the corresponding pixel values stored, e.g., in the memory 24 thus storing the resultant pixel values, wherein N is a total number of the dark frames to be captured (typically, N is between 2 and 16). N can be a predetermined set number or it can be adjusted (e.g., by a user of the electronic device 10 through a user interface).

In a next step 48, it is ascertained (e.g., by the module 22) whether all N dark frames are captured. If that is not the case, the process goes back to step 44 and the next dark frame is captured. If, however, it is ascertained that all N dark frames are captured, the process stops indicating that the dark frame subtraction is completed and the corrected frame signal 30 can be forwarded (optionally) to further modules.

Thus at the end of step 48, the memory contains dark frame subtracted pixel values, as demonstrated by the following simplified equations (note that the noise is not shown in the equations):

Memory content after storing the primary frame: s(signal)+d(dark signal);

Memory content after subtracting the first dark frame: s+d−d/N=s+d(N−1)/N;

Memory content after subtracting the second dark frame: s+d−2*d/N=s+d(N−2)/N, etc.

Memory content after subtracting the last dark frame s+d−N*d/N=s.

FIG. 2b shows a flow chart of another example of the divisional method for a dark frame subtraction using multiple dark frames by storing only one frame at a time, according to an embodiment of the present invention.

The flow chart of FIG. 2b only represents one possible scenario among others. In a method according to the first embodiment of the present invention, in a first step 50, the dark frame is captured (e.g., see the dark frame signal 26a) by the camera 12 when the mechanical shutter 16 is in the closed position, then the captured pixel values are divided by N (e.g., using the module 22a) and the divided pixel values of the dark frame are stored, e.g., in the memory 24, wherein N is a total number of the dark frames to be captured (typically, N is between 2 and 16).

In a next step 52, the next dark frame is captured. In a next step 54, the captured pixel values are divided by N (e.g., using the module 22a) and the divided pixel values are added to the corresponding pixel values stored, e.g., in the memory 24 thus storing the resultant pixel values.

In a next step 58, it is ascertained (e.g., by the module 22) whether all N dark frames are captured. If that is not the case, the process goes back to step 52. If, however, it is ascertained that all N dark frames are captured, in a next step 60, the primary frame is captured (e.g., see the primary frame signal 26) by the camera 12 when the mechanical shutter 16 is in the open position. In a next step 62, the resultant pixel values stored in the memory 24 are subtracted (e.g., by the module 22a) from the pixel values of the captured primary frame thus completing the dark frame subtraction (the corrected frame signal 30 can be forwarded to the further modules). It is noted that the subtraction of step 62 can be performed by adding the pixel values of the captured primary frame to the negative values of the resultant pixel values stored in the memory 24 (i.e., in steps 50 and 54, the negative pixel values of the dark frames are stored and added).

Thus at the end of step 62, the memory contains dark frame subtracted pixel values, as demonstrated by the following simplified equations (note that the noise is not shown in the equations):

Memory content after adding the first dark frame: (−)d/N

Memory content after adding the second dark frame: (−)2d/N, etc.

Memory content after adding the last dark frame (−)Nd/N=(−)d.

Memory content after subtracting from the primary frame: s+d−d=s.

FIG. 3a shows a flow chart of a multiplication method for a dark frame subtraction using multiple dark frames by storing only one frame at a time, according to an embodiment of the present invention.

The flow chart of FIG. 3a only represents one possible scenario among others. In a method according to the first embodiment of the present invention, in a first step 70, the primary frame is captured (e.g., see the primary frame signal 26) by the camera 12 when the mechanical shutter 16 is in the open position. In a next step 72, the primary frame is multiplied by N (e.g., using the module 22a) and stored, e.g., in the memory 24 (frame storage), N being a total number of the dark frames to be captured, typically, N being between 2 and 16 (N can be a predetermined set number or it can be adjusted, e.g., by a user of the electronic device 10 through a user interface).

In a next step 74, the dark frame is captured (e.g., see the dark frame signal 26a) by the camera 12 when the mechanical shutter 16 is in the closed position.

In a next step 76, the pixel values of the captured dark frame are subtracted from the corresponding pixel values stored, e.g., in the memory 24 thus storing the resultant pixel values.

In a next step 77, it is ascertained (e.g., by the module 22) whether all N dark frames are captured. If that is not the case, the process goes back to step 74 and the next dark frame is captured. If, however, it is ascertained that all N dark frames are captured, in a next step 78, the resultant pixel values stored in the memory 24 are divided by N thus completing the dark frame subtraction (the corrected frame signal 30 can be forwarded to the further modules).

Thus at the end of step 78, the memory contains dark frame subtracted pixel values, as demonstrated by the following simplified equations (note that the noise is not shown in the equations):

Memory content after storing and multiplying the primary frame: N*(s+d);

Memory contents after subtracting the first dark frame: N*(s+d)−d=N*s−(N−1)*d;

Memory content after subtracting the second dark frame: N*(s+d)−2*d=N*s−(N−2)*d, etc.;

Memory content after subtracting the last dark frame: N*(s+d)−N*d=N s;

Memory content after dividing by N: Ns/N=s.

FIG. 3b shows a flow chart of another example of the multiplication method for a dark frame subtraction using multiple dark frames by storing only one frame at a time, according to an embodiment of the present invention.

The flow chart of FIG. 3b only represents one possible scenario among others. In a method according to the first embodiment of the present invention, in a first step 80, the first dark frame is captured (e.g., see the dark frame signal 26a) by the camera 12 when the mechanical shutter 16 is in the closed position and the captured pixel values of the dark frame are stored, e.g., in the memory 24, wherein N is a total number of the dark frames to be captured (typically, between 2 and 16).

In a next step 82, the next dark frame is captured. In a next step 84, the captured pixel values of the dark frame are added to the corresponding pixel values stored, e.g., in the memory 24 thus storing the resultant pixel values.

In a next step 88, it is ascertained (e.g., by the module 22) whether all N dark frames are captured. If that is not the case, the process goes back to step 82. If, however, it is ascertained that all N dark frames are captured, in a next step 90, the primary frame is captured (e.g., see the primary frame signal 26) by the camera 12, when the mechanical shutter 16 is in the open position, and the captured pixel values are multiplied by N (e.g., using the block 22a). In a next step 92, the resultant pixel values stored in the memory 24 are subtracted (e.g., by the module 22a) from the multiplied by N pixel values of the captured primary frame. It is noted that the subtraction of step 92 can be performed by adding the multiplied by N pixel values of the captured primary frame to the negative values of the resultant pixel values stored in the memory 24 (i.e., in steps 80 and 84, the negative pixel values of the dark frames are stored and added). Finally in a next step 94, the resultant pixel values of step 92 are divided by N, thus completing the dark frame subtraction (the corrected frame signal 30 can be forwarded to the further modules).

Thus at the end of step 94, the memory contains dark frame subtracted pixel values, as demonstrated by the following simplified equations (note that the noise is not shown in the equations):

Memory content after adding the first dark frame: (−)d

Memory content after adding the second dark frame: (−)2d, etc.

Memory content after adding the last dark frame: (−)Nd

Memory content after subtracting from the primary frame multiplied by N: N(s+d)−dN=Ns.

Memory content after dividing by N: Ns/N=s.

If the multiplication method is used, the maximum value of each memory location should be large enough so that the data does not overflow when multiplied. For example, if 10 bit data is used and four dark frames are captured, at least 12-bit memory should be used. In practical implementations, the memory is often allocated in byte increments, e.g., for 10 bit data, two bytes are used for each pixel (16 bit). Therefore, the requirement for, e.g., 12 bit memory locations does not necessarily increase the amount of required memory.

As explained above, the invention provides both a method and corresponding equipment consisting of various modules providing the functionality for performing the steps of the method. The modules may be implemented as hardware, or may be implemented as software or firmware for execution by a computer processor. In particular, in the case of firmware or software, the invention can be provided as a computer program product including a computer readable storage structure embodying computer program code (i.e., the software or firmware) thereon for execution by the computer processor.

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method comprising:
capturing a primary frame and a plurality of dark frames by an electronic device;
performing a dark frame subtraction using said primary frame and said dark frames according to a predetermined algorithm by said electronic device by storing only one frame at any time during said capturing and said performing.

2. The method of claim 1, wherein said performing dark frame subtraction comprises:
storing pixel values of the primary frame in a memory of said electronic device; and
dividing pixel values of each of said plurality of the dark frames by a predetermined number equal to said plurality to generate divided pixel values and subtracting said divided pixel values of said each of said plurality of the dark frames from corresponding pixel values of the primary frames stored in the memory.

3. The method of claim 2, wherein said dividing and subtracting is performed for each of said plurality of the dark frames right after capturing said each dark frame such that none of the pixel values of said dark frames are stored in the memory, and said only one frame is stored in the memory at any time during said dividing and subtracting.

4. The method of claim 1, wherein said performing dark frame subtraction comprises:
multiplying each pixel value of the primary frame by a predetermined number equal to said plurality to generate multiplied pixel values and storing said multiplied pixel values in a memory of said electronic device; and
subtracting pixel values of each of said plurality of the dark frames from corresponding pixel values of said multiplied pixel values to generate subtracted pixel values and dividing said subtracted pixel values by said predetermined number.

5. The method of claim 4, wherein said subtracting is performed for each of said plurality of the dark frames right after capturing said each dark frame such that none of the pixel values of said dark frames are stored in the memory, and said only one frame is stored in the memory at any time during said multiplying and subtracting.

6. The method of claim 1, wherein said performing dark frame subtraction comprises:
dividing each pixel value of each of said plurality of the dark frames by a predetermined number equal to said plurality to generate divided pixel values and adding said divided pixel values of said each of said plurality of the dark frames one at a time to generate added pixel values and storing said added pixel values in a memory of said electronic device; and
subtracting said added pixel values of said plurality of the dark frames from corresponding pixel values of said primary frame.

7. The method of claim 6, wherein said dividing and adding is performed for each of said plurality of the dark frames right after capturing said each dark frame such that only one frame is stored in the memory at any time during said dividing, adding and subtracting.

8. The method of claim 1, wherein said performing dark frame subtraction comprises:
adding pixel values of each of said plurality of the dark frames one at a time to generate added pixel values and storing said added pixel values in a memory of said electronic device; and
multiplying each pixel value of the primary frame by a predetermined number equal to said plurality to generate multiplied pixel values and subtracting said added pixel values of the plurality of the dark frames from corresponding said multiplied pixel values of the primary frame to generate subtracted pixel values and dividing said subtracted pixel values by said predetermined number.

9. The method of claim 8, wherein said adding is performed for each of said plurality of the dark frames right after capturing said each dark frame such that said only one frame is stored in the memory at any time during said adding, multiplying, subtracting and dividing.

10. The method of claim 1, wherein said plurality has a value between two and sixteen.

11. The method of claim 1, wherein said electronic device comprising a camera performing said capturing of the primary frame and the plurality of the dark frames, and performing said dark frame subtraction.

12. A computer program product comprising: a computer readable storage structure embodying computer program code thereon for execution by a computer processor with said computer program code, wherein said computer program code comprises instructions for performing the method of claim 1, indicated as being performed by any component or a combination of components of said electronic device.

13. An electronic device, comprising:
a sensor, for capturing a primary frame and a plurality of dark frames;
a processing/control module, for performing a dark frame subtraction using said primary frame and said dark frames according to a predetermined algorithm by storing only one frame at any time during said capturing and said performing; and
a memory, for storing said only one frame during said capturing and said performing.

14. The electronic device of claim 13, further comprising:
a mechanical shutter, for providing said capturing of the plurality of the dark frames.

15. The electronic device of claim 14, wherein said mechanical shutter responsive to a control signal from the processing/control module to close for said capturing of the plurality of the dark frames or to open to capture said primary frame.

16. The electronic device of claim 14, wherein said sensor, said mechanical shutter and said processing/control module are parts of a camera.

17. The electronic device of claim 13, wherein said performing dark frame subtraction comprises:
storing pixel values of the primary frame in a memory of said electronic device; and
dividing each pixel value of each of said plurality of the dark frames by a predetermined number equal to said plurality to generate divided pixel values and subtracting said divided pixel values of said each of said plurality of the dark frames from corresponding pixel values of the primary frames stored in the memory.

18. The electronic device of claim 13, wherein said performing dark frame subtraction comprises:
multiplying each pixel value of the primary frame by a predetermined number equal to said plurality to generate multiplied pixel values and storing said multiplied pixel values in a memory of said electronic device; and
subtracting pixel values of each of said plurality of the dark frames from corresponding pixel values of said multiplied pixel values to generate subtracted pixel values and dividing said subtracted pixel values by said predetermined number.

19. The electronic device of claim 13, wherein said performing dark frame subtraction comprises:
dividing each pixel value of each of said plurality of the dark frames by a predetermined number equal to said plurality to generate divided pixel values and adding said divided pixel values of said each of said plurality of the dark frames one at a time to generate added pixel values and storing said added pixel values in a memory of said electronic device; and
subtracting said added pixel values of said plurality of the dark frames from corresponding pixel values of said primary frame.

20. The electronic device of claim 13, wherein said performing dark frame subtraction comprising:
adding pixel values of each of said plurality of the dark frames one at a time to generate added pixel values and storing said added pixel values in a memory of said electronic device; and
multiplying each pixel value of the primary frame by a predetermined number equal to said plurality to generate multiplied pixel values and subtracting said added pixel values of the plurality of the dark frames from corresponding said multiplied pixel values of the primary frame to generate subtracted pixel values and dividing said subtracted pixel values by said predetermined number.

21. The electronic device of claim 13, wherein said plurality has a value between two and sixteen.

22. An electronic device, comprising:
means for capturing a primary frame and a plurality of dark frames by an electronic device;
means for performing a dark frame subtraction using said primary frame and said dark frames according to a predetermined algorithm by said electronic device by storing only one frame at any time during said capturing and said performing; and
means for storing said only one frame during said capturing and said performing.

23. The electronic device of claim 22, wherein said means for capturing is an image sensor.
